(19) United States
(12) Patent Application Publication
(10) Pub. No.: US 2003/0006689 A1
(43) Pub. Date: Jan. 9, 2003

(54) Electron gun,cathode ray tube using the same, and method of manufacturing electron gun

(75) Inventors: Kazunori Ohta, Takatsuki (JP); Masahide Yamauchi, Kyoto (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Osaka (JP)

(21) Appl. No.: 10/188,589

(22) Filed: Jul. 2, 2002

(30) Foreign Application Priority Data
Jul. 6, 2001 (JP) 2001-205868

(51) Int. Cl. H01J 29/46

(52) U.S. Cl. 313/446

(57) ABSTRACT

A cathode, a control electrode, and an accelerating electrode are formed in this order, and electron beam passing holes for passing an electron beam emitted from the cathode are provided in the control electrode and the accelerating electrode, respectively. A concave portion is formed on a surface of the control electrode on a side of the accelerating electrode, and a convex portion is formed on a surface of the accelerating electrode on a side of the control electrode. This allows an actual gap between the control electrode and the accelerating electrode on a periphery of the electron beam passing holes to be reduced, and thus a voltage to be applied to the accelerating electrode can be reduced. Further, while the voltage of the accelerating electrode is suppressed, the electron beam passing hole of the control electrode can be reduced in diameter, and thus a beam spot formed on a phosphor screen can be reduced in diameter.

### BACKGROUND OF THE INVENTION

1. Field of the Invention

The present invention relates to an electron gun provided in a cathode ray tube used in a television set, a computer display or the like, the cathode ray tube, and a method of manufacturing an electron gun.

2. Related Background Art

In a high-resolution cathode ray tube, which is required to provide high quality images, an electron beam emitted from an electron gun provided in the cathode ray tube should land on a phosphor screen so as to form a beam spot of a small diameter.

One of the factors determining the spot diameter is an electron beam state in a triode portion composed of a cathode, a control electrode, and an accelerating electrode in the electron gun.

FIG. 8 shows a configuration of a triode portion of a conventional electron gun and the electron beam state in the triode portion. As shown in FIG. 8, an electron beam emitted from a cathode (K) 100 passes through a cathode lens 102 formed by the cathode 100 and a control electrode (G1) 101 and an electron beam passing hole 103 provided in a concave portion 110 of the control electrode 101, and forms a crossover. The electron beam further passes through an electron beam passing hole 105 of an accelerating electrode (G2) 104 and a pre-focusing lens 106 formed by the accelerating electrode 104 and a focusing electrode (not shown) and finally lands on a phosphor screen (not shown) in a cathode ray tube.

Due to the high spherical aberration of the cathode lens 102, particularly when a large electric current is passed, an electron beam 107 emitted from a peripheral portion of an electron-emitting surface of the cathode 100 and an electron beam 108 emitted from a paraxial portion are subjected to different lens actions from each other. This causes a positional difference between the crossovers formed by these electron beams. As a result, a crossover diameter 109, which defines a circle of least confusion of an electron beam flux, is increased, so that a beam spot of an increased diameter is formed on the phosphor screen.

Conventionally, this increase in spot diameter has been avoided in the following manner. That is, the electron beam passing hole 103 of the control electrode 101 is reduced in diameter so that the strength of an electric field between the cathode 100 and the control electrode 101 is increased. This causes the crossover diameter 109 to be reduced, and thus a beam spot of a reduced diameter is formed on the phosphor screen.

However, when the electron beam passing hole 103 of the control electrode 101 is reduced in diameter, as described above, the strength of the electric field between the cathode 100 and the control electrode 101 is increased, and thus it has been required that a higher voltage be applied to the accelerating electrode 104 as a voltage (Vg2) needed for electron beams to be emitted from the cathode 100.

When the higher voltage (Vg2) is applied to the accelerating electrode 104 as described above, sparks are caused in a socket used for voltage supply from a stem pin of the cathode ray tube and a circuit board. This can result in damage to the socket and the circuit board, which has been disadvantageous.

With the foregoing in mind, the present invention is to provide an electron gun in which, even when an electron beam passing hole of a control electrode is reduced in diameter, a reduction in a voltage to be applied to an accelerating electrode can be achieved using a simple electrode structure of an electron gun, and a cathode ray tube using the electron gun.

### SUMMARY OF THE INVENTION

In order to solve the aforementioned problem, an electron gun according to the present invention includes a cathode, an accelerating electrode, and a control electrode disposed between the cathode and the accelerating electrode. A first electron beam passing hole is provided in the control electrode, and a second electron beam passing hole is provided in the accelerating electrode. In the control electrode, a concave portion is formed on a side of the accelerating electrode, and in the accelerating electrode, a convex portion is formed so as to be opposed to the concave portion. The first electron beam passing hole is provided in the concave portion, and the second electron beam passing hole is provided in the convex portion.

According to this configuration, an actual gap between the control electrode and the accelerating electrode on a periphery of the electron beam passing holes can be reduced. Thus, a reduction in a voltage (Vg2) to be applied to the accelerating electrode can be achieved, thereby allowing damage to be prevented from being caused in a socket used for voltage supply to a stem pin of a cathode ray tube and a circuit board.

A method of manufacturing an electron gun according to the present invention is a method of manufacturing the above-mentioned electron gun according to the present invention. In the method, the accelerating electrode, a jig having a slot portion formed into a stripe, and the control electrode are laminated in this order so that the convex portion of the accelerating electrode is positioned in the slot portion. Later, the control electrode and the accelerating electrode are fixed, and then the jig is removed.

Thus, in a method of manufacturing an electron gun having a convex portion on a periphery of an electron beam passing hole of an accelerating electrode, a control electrode and the accelerating electrode are laminated while interposing a jig between them so that the convex portion is positioned in a slot portion of the jig. Therefore, the convex portion is not subjected to an unwanted stress when the jig is removed from between the electrodes, thereby preventing the electron beam passing hole from being deformed. Further, no flaw is caused in the vicinity of the electron beam passing hole in the convex portion, thereby preventing a problem of stray emission caused by electric field concentration.

### BRIEF DESCRIPTION OF THE DRAWINGS

FIG. 1 is a cross-sectional view of a triode portion of an electron gun according to an embodiment of the present invention.

FIG. 2 is a cross-sectional view of a cathode ray tube according to the embodiment of the present invention.

FIG. 3 is a graph showing a relationship between a gap between a control electrode and an accelerating electrode and the voltage of the accelerating electrode in the electron gun according to the embodiment of the present invention.

FIG. 4 is a cross-sectional view of a triode portion of an electron gun according to another embodiment of the present invention.

FIG. 5 is a cross-sectional view of an electron gun assembling apparatus used when assembling an electron gun.

FIG. 6 is a schematic diagram showing a spacer used in assembling a conventional electron gun.

FIG. 7 is a schematic diagram showing an embodiment of a spacer used in assembling the electron gun according to the present invention.

FIG. 8 is a cross-sectional view of a triode portion of the conventional electron gun.

### DETAILED DESCRIPTION OF THE INVENTION

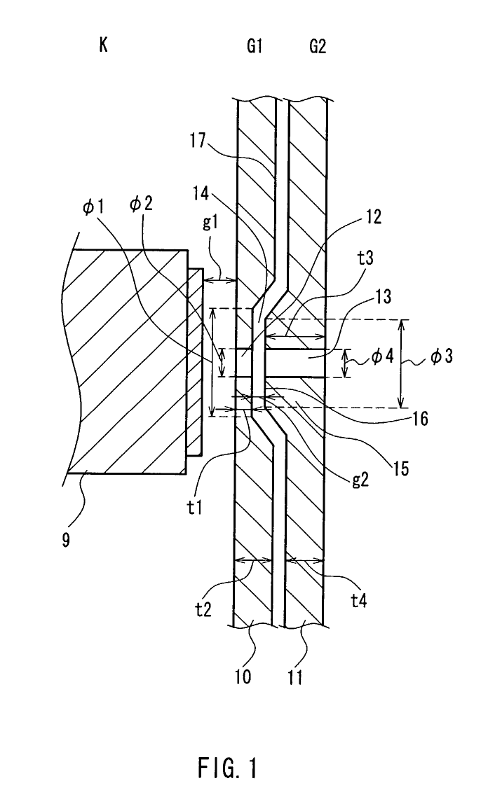

Hereinafter, an electron gun, a cathode ray tube using the electron gun, and a method of manufacturing an electron gun according to an embodiment of the present invention will be described with reference to FIGS. 1 to 7.

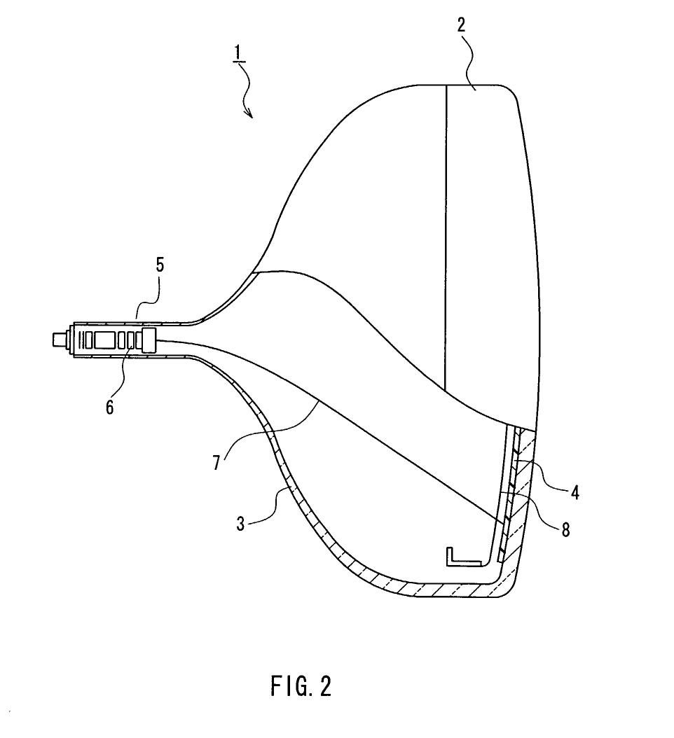

The description is directed first to a cathode ray tube that can be used with the electron gun of the present invention, with reference to FIG. 2.

As shown in FIG. 2, a cathode ray tube 1 includes an envelope composed of a panel 2 and a funnel 3. A phosphor screen 4 to which blue-, green-, and red-emitting phosphors are applied is formed on an inner surface of the panel 2. An electron gun 6 is housed in a neck portion 5 of the funnel 3 opposed to the phosphor screen 4. According to an input signal, electron beams 7 are emitted from the electron gun 6 so as to correspond to the respective colors of the above-mentioned phosphors. Then, the electron beams 7 land on the phosphor screen 4 through apertures formed in a shadow mask 8.

The description is directed next to the electron gun according to the embodiment of the present invention with reference to FIG. 1. FIG. 1 is a cross-sectional view of a triode portion of the electron gun according to the embodiment of the present invention.

As shown in FIG. 1, the electron gun according to the embodiment of the present invention includes a triode portion composed of a cathode (K) 9, a control electrode (G1) 10, and an accelerating electrode (G2) 11. Although not shown in the figure, the electron gun further includes a main lens portion composed of a focusing electrode and a final accelerating electrode, a shield cup, and two multi-foam glasses for coupling the electrodes to each other.

As shown in FIG. 1, the cathode 9, the control electrode 10, and the accelerating electrode 11 are disposed in this order at a predetermined spacing from each other. Further, in the control electrode 10 and the accelerating electrode 11, electron beam passing holes 12 and 13 for passing an electron beam emitted from the cathode 9 are provided, respectively.

Furthermore, on a surface of the control electrode 10 on a side of the accelerating electrode 11, a concave portion 14 of a circular form (coining form) is formed by recessing a periphery of the electron beam passing hole 12 by coining or the like. On a surface of the accelerating electrode 11 on a side of the control electrode 10, a convex portion 15 of a circular form is formed by convexing a periphery of the electron beam passing hole 13. Further, an upper surface portion 16 as a projected surface of the convex portion 15 is positioned so as to project into the concave portion 14 beyond a flat portion 17 of the control electrode 10 in which the concave portion 14 is not formed.

In an example of this embodiment, the concave portion 14 had a plate thickness t1 of 0.06 mm and a coining form diameter φ1 of 1.5 mm, the control electrode 10 had a plate thickness t2 of 0.17 mm in a portion in which the concave portion 14 was not formed, and the electron beam passing hole 12 had a hole diameter φ2 of 0.25 mm. Further, the convex portion 15 had a plate thickness t3 of 0.42 mm and a snout minor diameter φ3 of 1.23 mm, the accelerating electrode 11 had a plate thickness t4 of 0.25 mm in a portion in which the convex portion 15 was not formed, and the electron beam passing hole 13 had a hole diameter φ4 of 0.25 mm. Furthermore, the focusing electrode (not shown) on a side opposite the accelerating electrode had a plate thickness t5 of 0.35 mm, and an electron beam passing hole of the focusing electrode had a hole diameter φ5 of 0.9 mm. In operation, a gap g1 between the cathode 9 and the control electrode 10 was 0.07 mm, a gap g2 between a surface of the concave portion 14 of the control electrode 10 and the upper surface portion 16 of the convex portion 15 of the accelerating electrode 11 was 0.09 mm, and a gap g3 between the accelerating electrode 11 and the focusing electrode (not shown) was 0.7 mm.

When an electron gun having a triode portion of the above-mentioned configuration is used in a color picture tube, the cathode 9 has a voltage (Vkc: cutoff voltage) of about 170 to 180 V. Based on this, a test was performed by setting voltages of the following values to be applied to the electrodes in operation, respectively.

When the cathode 9 had a voltage (Vkc: cutoff voltage) of 170 V, the control electrode 10 had a voltage Vg1 of 0V, the focusing electrode (not shown) had a voltage Vg3 of 6.5 kV, and the final accelerating electrode (not shown) had a voltage Va of 32 kV, the accelerating electrode 11 had a voltage Vg2 of about 1,000 V. For comparison, a measurement was made also of the Vg2 of the accelerating electrode of a conventional electron gun in which a gap between the concave portion 14 of the control electrode 10 and the accelerating electrode 11 was 0.23 mm when the convex portion 15 was not formed (other conditions including the respective dimensions of the electrodes and the respective voltages applied to the electrodes were the same as those described above), and the result was about 2,300 V. This indicates that the voltage Vg2 of the accelerating electrode was reduced compared with the case of the conventional electrode gun.

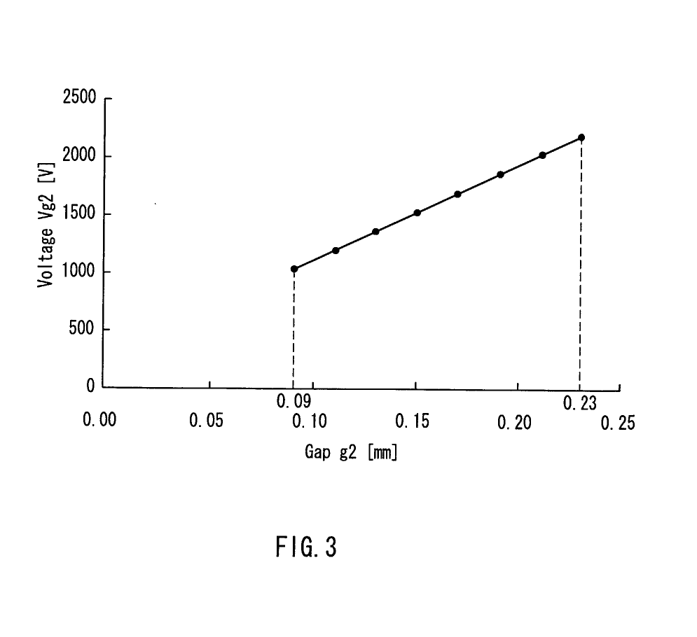

FIG. 3 shows variations in the voltage Vg2 of the accelerating electrode with respect to the gap g2 between the control electrode 10 and the accelerating electrode 11. The respective dimensions of electrodes and the respective voltages applied to the electrodes are the same as those described above.

As shown in FIG. 3, when the gap g2 is 0.09 mm, the voltage Vg2 is about 1,000 V. It is shown that the voltage Vg2 increases in proportion to the increasing gap g2. It also is shown that, when the gap g2 is 0.23 mm, the voltage Vg2 has substantially the same value of about 2,300 V as that of the voltage Vg2 of the conventional electron gun without the convex portion 15. When the gap g2 is not more than 0.09 mm, the following problems may arise. That is, an electric discharge may be caused between the control electrode 10 and the accelerating electrode 11, and the control electrode 10 and the accelerating electrode 11 may be brought into contact with each other by thermal expansion. Thus, the smallest gap g2 is limited to 0.09 mm.

Although not shown in the figure, in this electron gun, a high voltage of 25 kV to 35 kV is applied to the final accelerating electrode from a funnel through an inner wall, voltages of arbitrary values are applied respectively to the electrodes other than the final accelerating electrode from a stem portion fixed to a neck portion, and a voltage of about 5 kV to 8 kV is applied to the focusing electrode.

When the above-mentioned voltages are applied to the electrodes, respectively, an electron beam is emitted from the cathode 9 and forms a crossover in the vicinity of the accelerating electrode 11 by a cathode lens formed by the cathode 9, the control electrode 10, and the accelerating electrode 11. Then, the electron beam emitted from the crossover at a given angle of divergence is focused preliminarily by a pre-focusing lens formed by the accelerating electrode 11 and the focusing electrode (not shown). After that, the electron beam is incident on a main lens formed by the focusing electrode and the final accelerating electrode and focused to form a beam spot on a phosphor screen.

The electron gun according to the present invention allows the electron beam passing hole 12 of the control electrode 10 to be reduced in diameter so that the strength of an electric field between the cathode 9 and the control electrode 10 is increased. Thus, a beam spot formed on a phosphor screen can be reduced in diameter, thereby allowing a high-resolution cathode ray tube to be obtained. Further, even when the electron beam passing hole 12 is reduced in diameter, a reduction in the voltage Vg2 of the accelerating electrode 11 can be achieved. Thus, a socket used for voltage supply to a stem pin of a cathode ray tube or a circuit board is prevented from being damaged, thereby allowing a high-quality electron gun and cathode ray tube to be obtained. Hence, an electron gun and a cathode ray tube can be obtained that are highly reliable even after long hours of use.

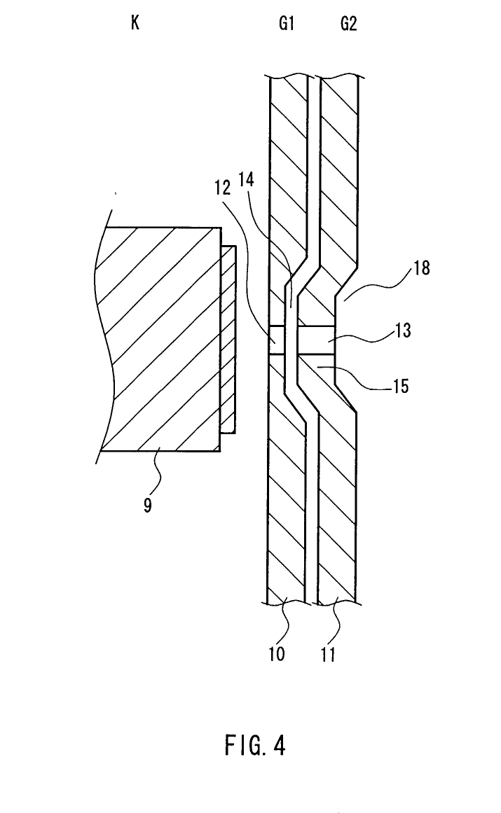

As shown in FIG. 4, an accelerating electrode may be of the following structure. That is, on a surface of the accelerating electrode 11 on which the convex portion 15 is not formed, a concave portion 18 is provided so that the plate thickness of a portion in which the convex portion 15 and the concave portion 18 are formed and the plate thickness of a portion in which the convex portion 15 and the concave portion 18 are not formed are made substantially even. In the figure, like reference numerals indicate like constituent elements of the triode portion shown in FIG. 1, for which duplicate descriptions are omitted.

In the accelerating electrode 11 shown in FIG. 4, a member having a constant plate thickness is pressed, in a portion in which the electron beam passing hole 13 is to be formed, into a coining form, thereby allowing a manufacturing process to be made easier by eliminating the need for hollowing out a plate material or bonding two members to each other.

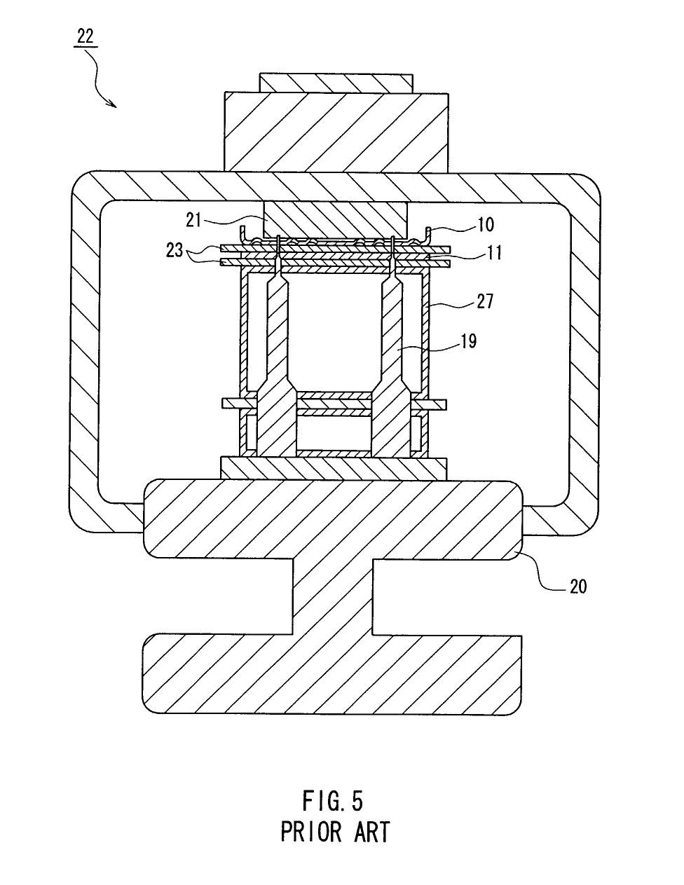

The description is directed further to the method of manufacturing an electron gun according to the embodiment of the present invention with reference to FIG. 5.

Generally, an electron gun is composed of a plurality of electrodes each having three electron beam passing holes and manufactured by fixing these electrodes. As shown in FIG. 5, manufacturing of the electron gun in which the plurality of electrodes are fixed is performed by using an electron gun assembling apparatus 22 including a lower electrode 20 provided with two position regulating pins 19 and an upper electrode 21. On the lower electrode 20, a focusing electrode 27, an accelerating electrode 11, a control electrode 10 are laminated in this order, and lastly, the upper electrode 21 is laminated so as to be pressed against the control electrode 10 (electrode-laminating process). Then, side portions of each of the electrodes are fixed to supporting rods (not shown) made of a glass material or the like so that the electrodes are connected to each other and fixed (electrode-fixing process). In fixing the electrodes, gaps between the respective electrodes and positions of the electron beam passing holes of the respective electrodes are required to be regulated precisely.

The regulation of the positions of the electron beam passing holes of the respective electrodes is performed in the following manner. That is, each of the electrodes is laminated so that the two position regulating pins 19 are inserted into two of the three electron beam passing holes provided in each of the electrodes, which correspond to both side electron beams.

The regulation of the gaps between the respective electrodes is performed by laminating the electrodes so that spacers 23 are interposed between the respective electrodes in the electrode-laminating process.

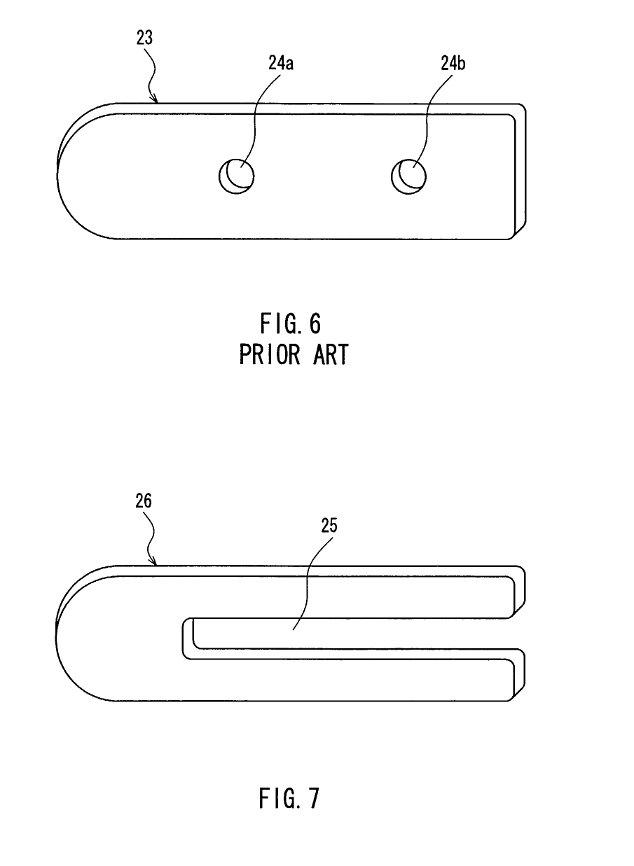

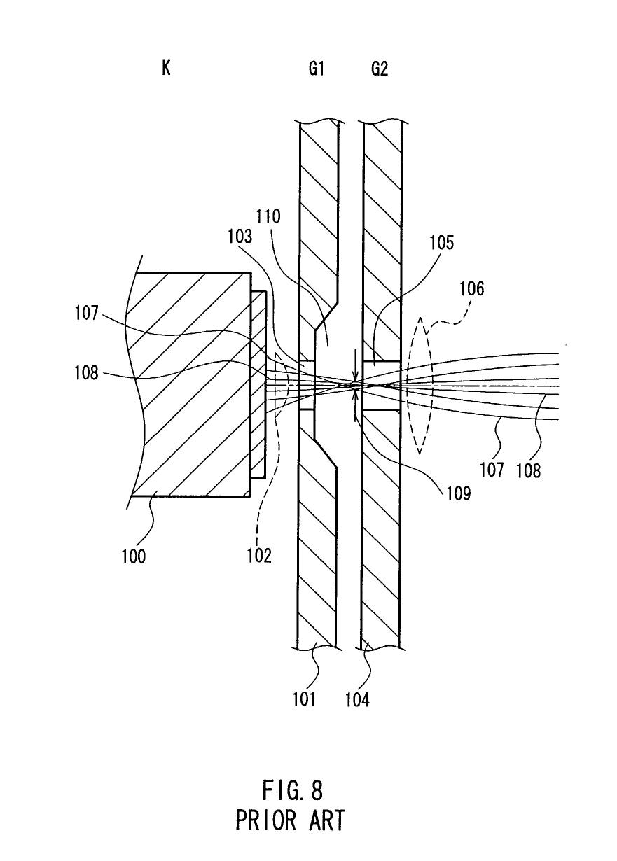

As shown in FIG. 6, the conventional spacer 23 has been of the following configuration. That is, two holes 24a and 24b are formed so as to correspond to the electron beam passing holes of each of the electrodes corresponding to both side electron beams. Conventionally, manufacturing of an electron gun has been performed by the following method. That is, the electrodes are laminated so that the spacers 23 are interposed between the focusing electrode 27 and the accelerating electrode 11 and between the accelerating electrode 11 and the control electrode 10, respectively, while allowing the position regulating pins 19 to be inserted into the holes 24a and 24b of each of the spacers 23. Later, each of the electrodes is fixed to the supporting rods, and then the position regulating pins 19 are pulled out of the electron beam passing holes. After that, the spacers 23 that have been interposed between the respective electrodes are removed therefrom by being pulled in a lateral direction of a plane on which the figure is drawn in FIG. 5.

However, in the electron gun according to the embodiment of the present invention, as shown in FIG. 1, the convex portion 15 is formed in the accelerating electrode 11, and thus an attempt to remove the spacer after fixing each of the electrodes results in the spacer being caught in the convex portion 15.

In order to solve this problem, in the method of manufacturing an electron gun according to the present invention, particularly, in a process of assembling an electron gun, a spacer 26 is used that has a horseshoe or “U” form having a slot portion 25 formed into a stripe as shown in FIG. 7. The electrodes are laminated while interposing the spacer 26 at least between the control electrode 10 and the accelerating electrode 11 in which the convex portion 15 is formed so that the convex portion 15 is fitted into the slot portion 25. Then, after these electrodes are fixed, the spacer 26 is removed. The spacer 26 may be made of a material such as SK steel (carbon tool steel) and a brass-base material, having a surface plated with diamond.

By using this spacer 26 having the slot portion 25, the spacer 26 can be removed from between the electrodes so as not to be caught in the convex portion 15. Further, the spacer 26 can be removed from between the electrodes even before the position regulating pins 19 are pulled out of the electron beam passing holes of each of the electrodes.

Furthermore, a gap (gap between the surface of the concave portion 14 on the periphery of the electron beam passing hole 12 and the convex portion 15) between the control electrode 10 on the periphery of the electron beam passing hole 12 and the accelerating electrode 11 that contributes to the deflection of an electron beam can be controlled accurately by the thickness of the spacer 26. Thus, variations in properties of manufactured electron guns can be suppressed.

As described above, the method of manufacturing an electron gun according to the present invention allows a jig (spacer 26) interposed between electrodes to be removed without causing deformation of an electron beam passing hole, thereby allowing a high-quality electron gun to be obtained with an improved manufacturing yield.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An electron gun comprising a cathode, an accelerating electrode, and a control electrode disposed between the cathode and the accelerating electrode, in which a first electron beam passing hole is provided in the control electrode, and a second electron beam passing hole is provided in the accelerating electrode,
wherein a concave portion is formed in the control electrode on a side of the accelerating electrode, and a convex portion is formed in the accelerating electrode so as to be opposed to the concave portion; and
the first electron beam passing hole is provided in the concave portion, and the second electron beam passing hole is provided in the convex portion.

2. The electron gun according to claim 1, wherein the convex portion is positioned so as to project into the concave portion.

3. The electron gun according to claim 1, wherein a gap g2 (mm) between the control electrode and the accelerating electrode satisfies the relationship 0.09≦g2≦0.23.

4. A cathode ray tube comprising the electron gun according to claim 1.

5. A method of manufacturing an electron gun, the electron gun being the electron gun according to claim 1, which comprises:
laminating the accelerating electrode, a jig having a slot portion formed into a stripe, and the control electrode in this order so that the convex portion of the accelerating electrode is positioned in the slot portion;
fixing the control electrode and the accelerating electrode that have been laminated; and
removing the jig after the control electrode and the accelerating electrode are fixed.

6. The method according to claim 5, wherein the jig is in the form of a horseshoe.
